(19) United States
(12) Patent Application Publication
(10) Pub. No.: US 2015/0225980 A1
(43) Pub. Date: Aug. 13, 2015

(54) CYLINDER THUMB-TURN and IMPROVED LOCKING SYSTEM

(71) Applicants: ALEXANDER KLEINER, QIRYAT GAT (IL); GRIGORY ORENBAKH, QIRYAT GAT (IL)

(72) Inventors: ALEXANDER KLEINER, QIRYAT GAT (IL); GRIGORY ORENBAKH, QIRYAT GAT (IL)

(21) Appl. No.: 14/547,405

(22) Filed: Nov. 19, 2014

(30) Foreign Application Priority Data
Feb. 11, 2014 (IL) IL2014/230924

(51) Int. Cl. E05B 15/00

(52) U.S. Cl. CPC E05B 15/00

(57) ABSTRACT

The proposed invention refers to devices for opening and closing of cylinder-type locks, and is comprised of:
i. Lock according to patent application Ser. No. IL2011/211,924 with additional gearwheel.
ii. Cylinder Thumb-Turn that opens/closes the lock both from inside and outside.
iii. External flange wherein Cylinder Thumb-Turn can rotate freely while opening/closing the lock.
iv. Lock according to patent application Ser. No. IL2011/211,924 that cannot be opened when gearwheels A and B are disconnected.
v. Remote control lever according to patent application Ser. No. IL2011/211,924 with additional gearwheel that opens/closes the lock manually (or electronically by using electromagnet) once the remote control lever receives command to join gearwheels A and B.
vi. Flanges covering Cylinder Thumb-Turn, with watertight seal pads.

### TECHNICAL FIELD

The proposed invention refers to devices for opening and closing of cylinder-type locks.

### BACKGROUND ART

In an existing patent application Ser. No. IL2011/211,924 the cylinder can be detached from the bolt which makes it impossible to open the lock with any key (including its original key). However, if a burglar cannot pick a lock, he will knock the cylinder out and access the latch via the resulting space. In another U.S. Pat. No. 4,384,465 of May 24,1983 —a cylinder called Cylinder Thumb-Turn is used. This cylinder has a serious drawback: it can only be used to open/close the lock from inside the room.

There are other American and European Thumb-Turn Cylinders that can open/close the lock from both sides. But they all share the same drawback as regular cylinders: they can be knocked out if the burglar cannot open them. The proposed Cylinder Thumb-Turn modification is impossible to knock out, and can be used to open/close the lock both from inside and outside the room.

### SUMMARY OF INVENTION

The proposed invention refers to devices for opening and closing of cylinder-type locks, and is comprised of:

Lock according to patent application Ser. No. IL2011/211,924 with additional gearwheel

(ii) Cylinder Thumb-Turn that opens/closes the lock both from inside and outside

(iii) External flange wherein Cylinder Thumb-Turn can rotate freely while opening/closing the lock

(iv) Lock according to patent application Ser. No. IL2011/211,924 that cannot be opened when gearwheels A and B are disconnected.

(v) Remote control lever D according to patent application Ser. No. IL2011/211,924 with additional gearwheel that opens/closes the lock manually (or electronically by using electromagnet) once the remote control lever receives command to join gearwheels A and B

(vi) Flanges covering Cylinder Thumb-Turn, with watertight seal pads

### BRIEF DESCRIPTION OF DRAWINGS

FIG. 1a and FIG. 1b (side plan) show the position of the lock gearwheels according to patent application Ser. No. IL2011/211,924 wherein an additional gearwheel and a Cylinder Thumb-Turn are installed instead of the gearwheel of the cylinder used in patent application Ser. No. IL2011/211,924. Gearwheel B is permanently connected to cam90 ( ) that converts the rotation of gearwheel B into the translatory motion of the latch.

FIG. 2 (isometric view) shows the lock according to the proposed invention wherein the lock differs from that of the main patent in that a Cylinder Thumb-Turn and an additional gearwheel are permanently installed instead of the cylinder used in the main patent.

FIG. 2a (isometric view) shows the gearwheels and the Cylinder Thumb-Turn, enlarged.

FIG. 3 (front view) shows the subject lock in a door frame (door not shown). FIG. 3a (front view) shows the subject lock with the casing and the inner flange. FIG. 3b (isometric view) shows Cylinder Thumb-Turn. FIG. 3c (cross-section C-C) shows Cylinder Thumb-Turn head inside the outer flange.

FIG. 4 (isometric view) shows the subject lock assembly and the door. The lock is installed in the door, with the inner flange and parts of the subject lock shown. FIG. 4a (isometric view) shows the assembly of the outer and inner flanges (door not shown).

### DETAILED DESCRIPTION OF THE INVENTION

The subsequent detailed description of the proposed patent presents its preferred design, accompanied by drawings showing how to practically use the patent. Other design solutions that conform to the formula of the patent and cannot be recognized as independent patents are possible within the framework of this patent.

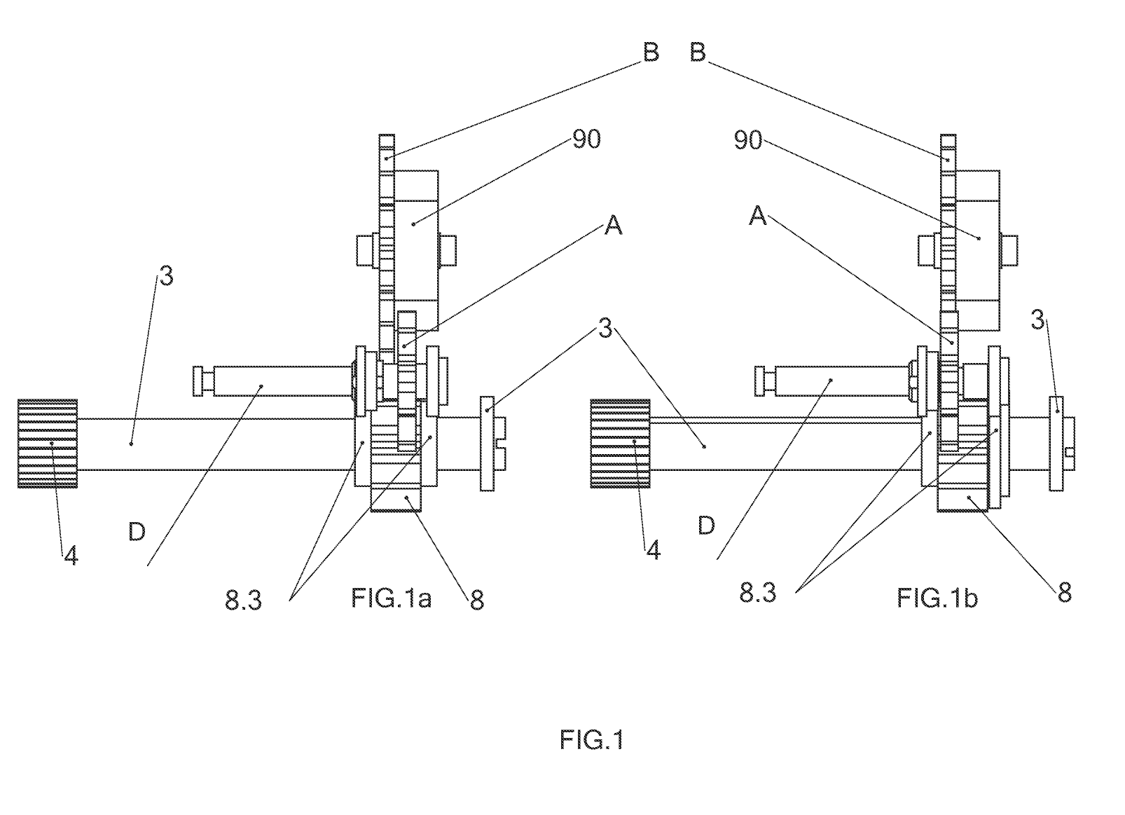

FIG. 1 shows the location of the gearwheels in the lock according to patent application Ser. No. IL2011/211,924 which comprises gearwheel 8, the parameters thereof match those of the cylinder 10 and gearwheel 30 used in the lock according to the above patent. Cylinder Thumb-Turn 3 with handle 4, control lever D and sleeves 8-3 wherein gearwheel 8 rotates are also visible. FIG. 1a shows gearwheels A and B disengaged. FIG. 1b shows the same so gearwheels engaged.

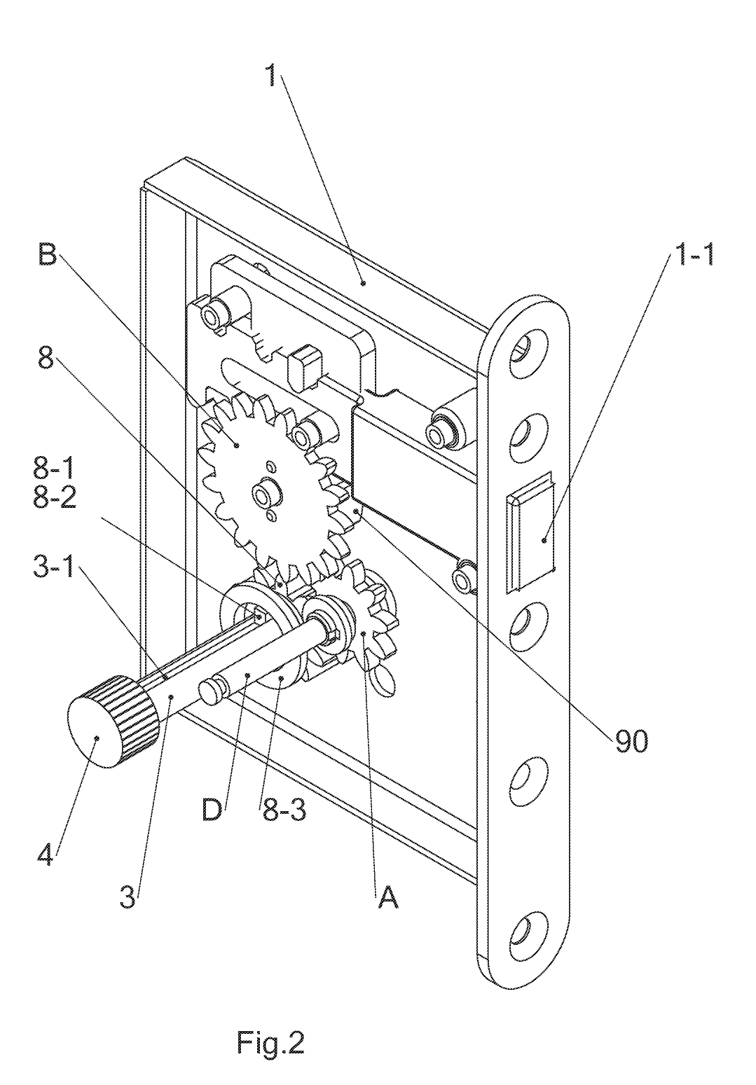

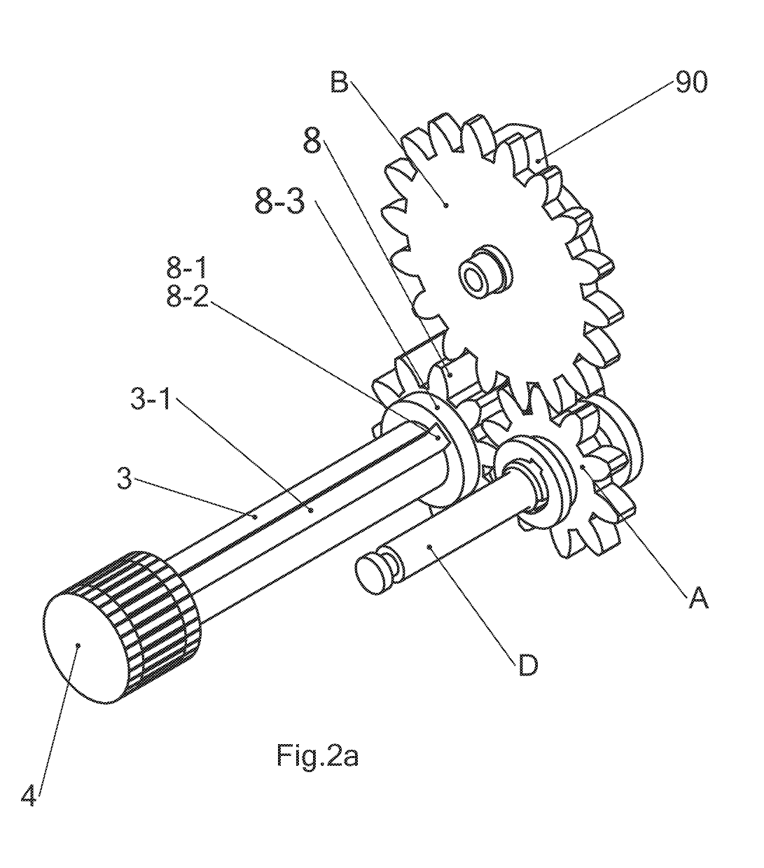

FIG. 2 shows a lock according to the proposed invention, which differs from patent application Ser. No. IL2011/211,924 in that the standard cylinder with a gearwheel is replaced with a permanently installed gearwheel 8 and Cylinder Thumb-Turn 3. gearwheel 8 has a keyway 8-1 to engage with Cylinder Thumb-Turn 3 which also has a matching keyway 3-1. During the lock assembly process, pin 8-2 is pressed into keyway 8-1 of gearwheel 8. Housing 1, as well as the outer and inner surfaces of the door 2 are provided with holes for Cylinder Thumb-Turn 3 (door not shown) that with handle 4 rotating the cylinder. When handle 4 turns, Cylinder Thumb-Turn 3 brings gearwheel 8 into rotation; gearwheel 8 rotates the movable gearwheel A wherein gearwheel A is in constant mesh with gearwheel B. The movement of control lever D—handle (located in the lock from inside of the door (FIGS. 1, 2, 3, 4)) is actuated by hand or by an electromagnet using a remote, and engages or disengages gearwheel A with gearwheel B wherein gearwheel B is constantly connected to the cam 90 wherein cam 90 moves the latch 1-1 of lock 1, closing or opening lock 1 depending on the direction of Cylinder Thumb-Turn 3 rotation (only when gearwheel A is engaged with gearwheel B).

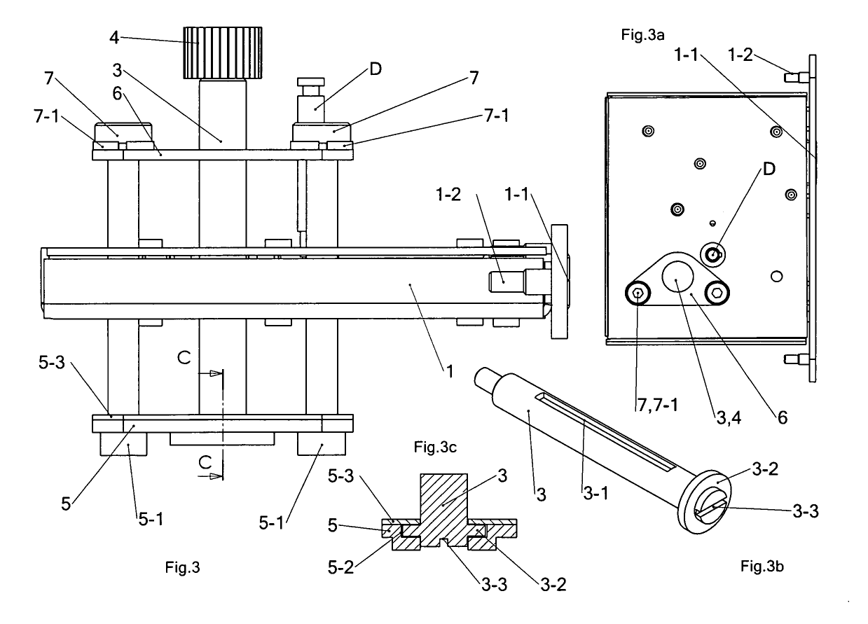

FIG. 3 shows the assembled lock according to the claim, but without the door in which it is installed. Cylinder Thumb-Turn 3 is mounted on lock 1 from outside the room, and engages with gearwheel 8. Key 8-2 engages with groove 3-1 of Cylinder Thumb-Turn 3. Cylinder Thumb-Turn 3 passes through the inner flange 6, and handle 4 is mounted on the cylinder thumb turn. Outer flange 5 fully covers the cylinder thumb turn (FIG. 3c), and there is no access to it from the outside (FIG. 3c). Head 3-2 of Cylinder Thumb-Turn 3 is engaged with recess 5-2 of flange 5 (FIG. 3c). Cylinder Thumb-Turn 3 opens the lock from the outside manually. (Shape and dimensions of the slot 3-3 are arbitrary and are determined by the manufacturer).

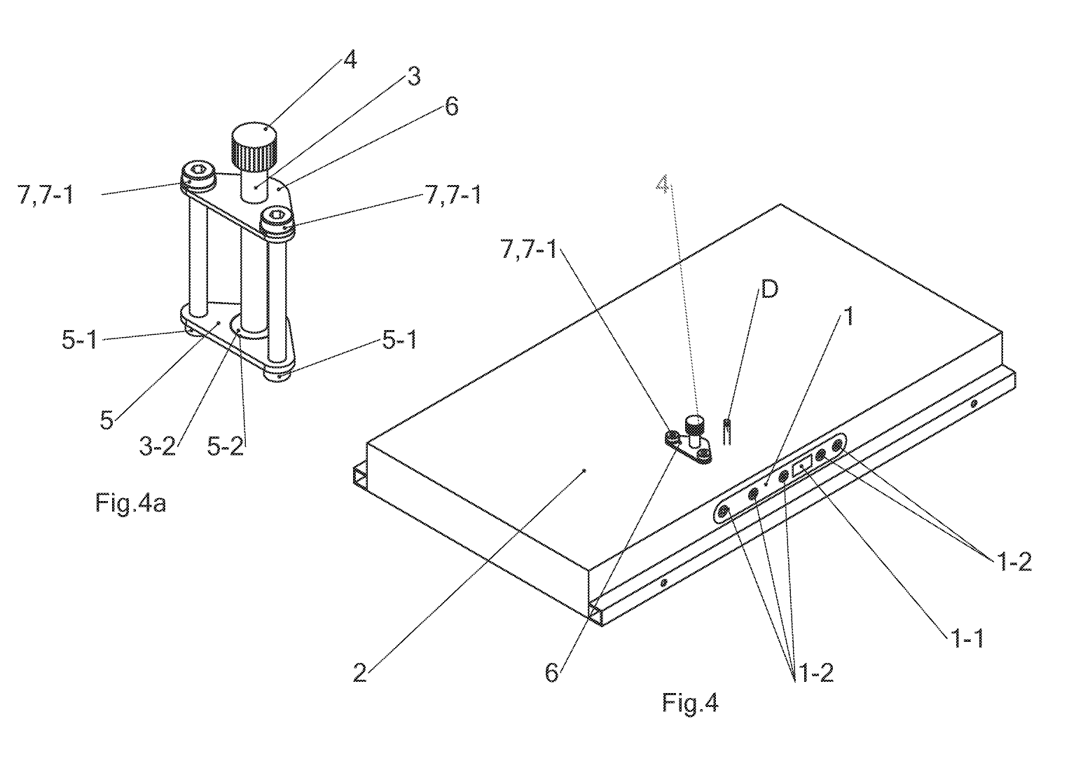

FIG. 4 shows a door with the lock, screws 1-2 mounting the lock on the door, latch 1-1, internal flange 6 and screws 7 with spring washers mounting the flange. FIG. 4a shows how flanges 5 and 6 are mounted, with spring washers 7-1 preventing their loosening. Gasket 5-3 (not shown in FIG. 4, shown in FIG. 3, FIG. 3c) installed under flanges 5 for sealing. There is no outside access to screws 7 threaded into bosses of flange 5-1. FIG. 4a also shows the mounting of Cylinder Thumb-Turn 3 whose head is in a recess 5-2 of flange 5 where said head rotates freely. Lock 1 cannot be opened from the outside if gearwheels A and B are not engaged. This increases the level of protection, as it is impossible to knock Cylinder Thumb-Turn out of the door and reach the lock mechanism. Gearwheels A and B, latch 1-1, and the drive (control lever) of the mechanism engaging/disengaging the gearwheels used in patent application Ser. No. IL2011/211,924 remain unchanged. Cylinder Thumb-Turn 3 opens and closes the lock from inside the room by turning handle 4 when gearwheels A and B are engaged.

FIG. 4 (isometric view) shows a common standard door that does not require changes in technology or equipment to embed the lock according to this claim, which 100 provides reliable protection from unlawful opening. The electromagnet (electric motor) with a remote control unit is used to engage/disengage the cylinder and the latch in patent application Ser. No. IL2011/211924; the same construction applies to Cylinder Thumb-Turn control.

1. The patent comprises:
(i) A lock according to the invention claimed
(ii) Cylinder Thumb-Turn
(iii) The door with the lock installed
(iv)The remote control unit according to the main patent, augmented by a device that prevents Cylinder Thumb-Turn from rotation when the movable gearwheel is inadvertently engaged with the latch gearwheel.
(v) The remote control unit according to the main patent, augmented by a remote control unit that opens/closes the lock after a command is sent to engage the no movable gearwheel with the latch gearwheel.

2. The main parameters (module and number of teeth) of the gearwheel coincide with the main parameters of the cylinder gearwheel of the main patent.

3. The gearwheel according to claim 1 is permanently installed in the lock and is permanently engaged with the movable gearwheel.

4. The gearwheel according to claims 1 and 2 is driven by Cylinder Thumb-Turn.

5. Cylinder Thumb-Turn (ii) can lock/unlock the door from inside and from the outside.

6. Cylinder Thumb-Turn according to claim 4 is installed between the outer surface of the door and the outer flange.

7. The outer flange according to claim 5 has a recess housing the Cylinder Thumb-Turn head.

8. Cylinder Thumb-Turn according to claims 4 and 5, outer and inner flanges have watertight seal pads.
